(19) United States
(12) Patent Application Publication
(10) Pub. No.: US 2008/0198995 A1
(43) Pub. Date: Aug. 21, 2008

(54) System and method for providing a search portal with enhanced results

(76) Inventors: Faith McGary, Bethlehem, PA (US); Ian Bacon, Fairfax, VA (US)

Correspondence Address: SOFER & HAROUN LLP., 317 MADISON AVENUE, SUITE 910, NEW YORK, NY, 10017, US

(21) Appl. No.: 11/985,327

(22) Filed: Nov. 14, 2007

Related U.S. Application Data
(60) Provisional application No. 60/859,024, filed on Nov. 14, 2006.

(51) Int. Cl. H04M 3/42; G06F 17/30

(52) U.S. Cl. 379/218.01; 707/3; 707/E17.001

(57) ABSTRACT

A system for providing search results having a portal for receiving search requests and a means for obtaining prior search results from telephonic directory assistance requests. A trend module analyzes the obtained prior search results from telephonic directory assistance requests; where results provided to a user in response to the search request received at the portal are affected by the prior search results from telephonic directory assistance requests.

### RELATED APPLICATION

This application claims the benefit of priority from U.S. Provisional Patent Application No. 60/859,024, filed on Nov. 14, 2006, the entirety of which is incorporated herein by reference.

### FIELD OF THE INVENTION

The present invention relates to search portals. More particularly, the present invention relates to improved results for search portals using prior obtained data.

### BACKGROUND

The traditional manner for obtaining contact information for a desired party is directory assistance, where a caller contacts a directory assistance platform and requests a contact information such as the telephone number of a business or residence.

More recently, with the ever increasing capacity of mobile wireless communication devices, additional search portals used for obtaining contact information are web search engines such as Yahoo™ or Google™ However, both systems have some drawbacks regarding cost and efficiency. For example, traditional telephonic directory assistance systems require the caller to contact the system by a telephone call, wait for the search, receive the results, and then contact (or be connected to) the desired listing. Not only is this time consuming, but it also typically has an associated charge per contact. Furthermore, if the information is incorrect, or if additional information is desired, the caller needs to re-connect the system with an additional associated charge.

Newer web enabled mobile devices allow users to directly connect to web search portals allowing them to perform a web search for a desired contact information without an associated directory assistance charge. These web searches employ algorithms to provide search results based on the terms entered. This typically results in a long list of potential results. For example, in what would be a typical web search for a business, such as a category search for “Hotel” in New York City” the list would likely include hundreds of results all of which would include the world “hotel” and “New York City” somewhere in the results.

However, these results lists generally are limited to results directly garnered from the search terms entered by the user, which would obviously require the user to perform several searches if they intend to obtain different types of information, each search requiring time for entering or typing the search and receiving the requested data.

### OBJECTS AND SUMMARY

The present invention looks to overcome certain drawbacks associated with the prior art and to provide improved search portal results, particularly web search results, by enhancing the results using past traditional directory assistance results.

To this end, the present invention is directed to a system for providing search results having a portal for receiving search requests and a means for obtaining prior search results from telephonic directory assistance requests. A trend module analyzes the obtained prior search results from telephonic directory assistance requests; where results provided to a user in response to the search request received at the portal are affected by the prior search results from telephonic directory assistance requests.

### BRIEF DESCRIPTION OF THE DRAWINGS

The present invention can be best understood through the following description and accompanying drawings, wherein:

FIG. 1 illustrates a system for providing search results, in accordance with one embodiment of the present invention;

FIG. 2 illustrates an exemplary call record from a directory assistance call, in accordance with one embodiment of the present invention;

FIG. 3 is a table showing call trend data, in accordance with one embodiment of the present invention;

FIG. 4 is a table showing call trend data, in accordance with another embodiment of the present invention;

FIG. 5 is a table showing call trend data, in accordance with another embodiment of the present invention;

FIG. 6 is a table showing call trend data, in accordance with another embodiment of the present invention;

FIG. 7 is a table showing call trend data, in accordance with another embodiment of the present invention;

FIG. 8 is a table showing call trend data, in accordance with another embodiment of the present invention; and

FIG. 9 is a table showing call trend and clustering data, in accordance with another embodiment of the present invention.

### DETAILED DESCRIPTION

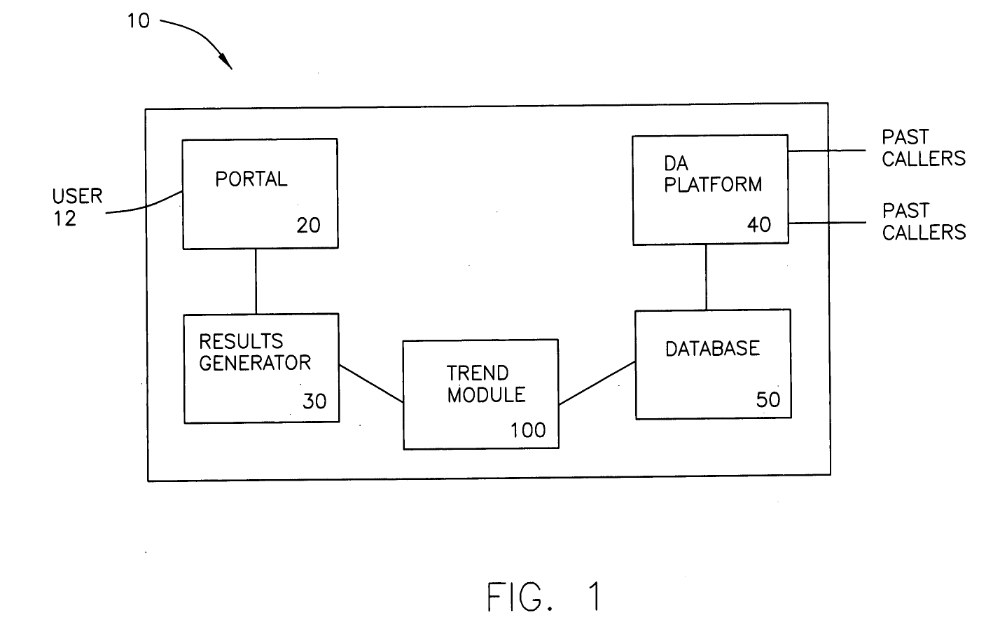

In one embodiment of the present invention, as illustrated in FIG. 1, a system 10 for providing search results is provided. System 10 maintains a search portal 20, such as a web search portal configured to provide an interface for contact by a user 12 (using digital mobile phones, WiFi laptops, PDAs etc . . . ) desiring some contact information.

Search portal 20 is preferably a typical web search portal and accompanying servers for allowing user 12 to enter search terms that are searched against content on the internet. Search portal 20 provides a set of results to user 12 relating to their requested search.

Search portal 20 employs a results generator module 30 that employs one or more algorithms to generate the desired search results. The search terms entered by user 12 are provided by portal 20 to results generator 30 which in turn provides the desired results list back to portal 20 for presentation to user 12.

In one embodiment of the present invention, portal 20 and results generator module 30 may employ enhanced search features, such as indexing and filtering to limit the amount of web pages, so that the search terms for the desired item are checked against a quantity of indexed web pages that are managed based on the feedback imparted from prior users 12. Additionally, this indexing and filtering may be further enhanced by importing data from other user feedback content contained on other web portals, web pages, web communities or web analysis entities.

Regarding internal feedback imparted from prior users 12 of system 10, users 12 of portal 20 are encouraged through various incentives (ie. digital coupons or enhanced services, etc . . . ) to rate websites, that are retrieved in response to a web search, as to their relevance and accuracy regarding certain topics.

In order to implement such a search, results generator 30 and portal 20 of the present invention contemplates, among other features, to utilize a “viral community” of users 12 to assist in generating feedback to help to assist in managing the indexed web pages.

When any user 12 performs a search, that user's 12 search term for a desired item is searched by results generator 30 against the general internet content. The results list may be shortened or otherwise enhanced in relevancy using the index/weighted data provided by the responses of previous users 12 or other third party rating data as noted above.

Results generator 30 may further enhance the results list for user 12 by utilizing user's 12 physical location, tying in additional information/on-line encyclopedia links. Furthermore, user 12 may tailor their results by weighting the search on portal 20 using scales ranging from “more commercial” to “more informational” web sites.

In another embodiment of the invention, shown in FIG. 1, system 10 also maintains a traditional directory assistance platform 40, such as a telephonic directory assistance system having automated or live operators, switching equipment, listing databases and other information used to provide contact information to inquiring callers.

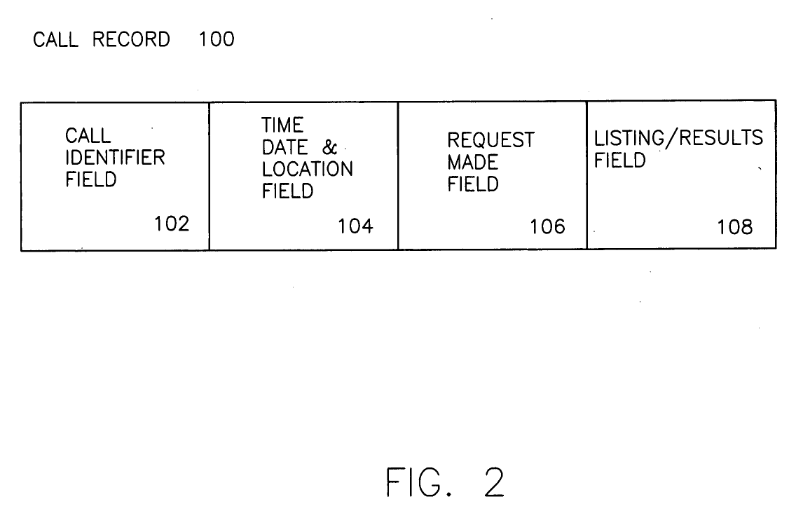

System 10 further maintains a storage database 50 that keeps track of past requests made by callers to directory assistance platform 40 in the form of a call record 100. An exemplary call record 100 is shown in FIG. 2, having a caller identifier field 102 (e.g. including caller ANI (automatic number identifier)), a time, date and location field 104, a request field 106 that shows the request term or terms used by the caller and a listing field 108 showing the listing code for the listing that was supplied in response to the request and potentially including the SIC (Standard Industry Code—“category”) for that listing.

It is noted that although web portal 20, results generator 30 and directory assistance platform 40 are all shown within system 10 it is contemplated that each component may be remotely located, run by third party entities, and may be comprised of multiple sub-units/servers, such as server farms, large combined database warehouses, and operator terminal (in the case of DA platform 40) may be employed within the context of this invention. Furthermore, it is understood that although many types of searches may be requested via web portal 20 and directory assistance platform 40 such as white pages requests, or other random information searches, the exemplary embodiments of the present invention are discussed below in the context of a “yellow pages” type category search for business or commercial listing.

In one embodiment of the present invention, system 10 maintains a trend module 60 configured to utilize the prior search data from stored call records 100 to develop narratives or “stories” around which to enhance result provided to a user 12 of search portal 20. This allows the present invention to provide a search result that includes not only the requested information based on the search terms, but also additional potential related links or other information that may be of use to the user that are in line with the narrative.

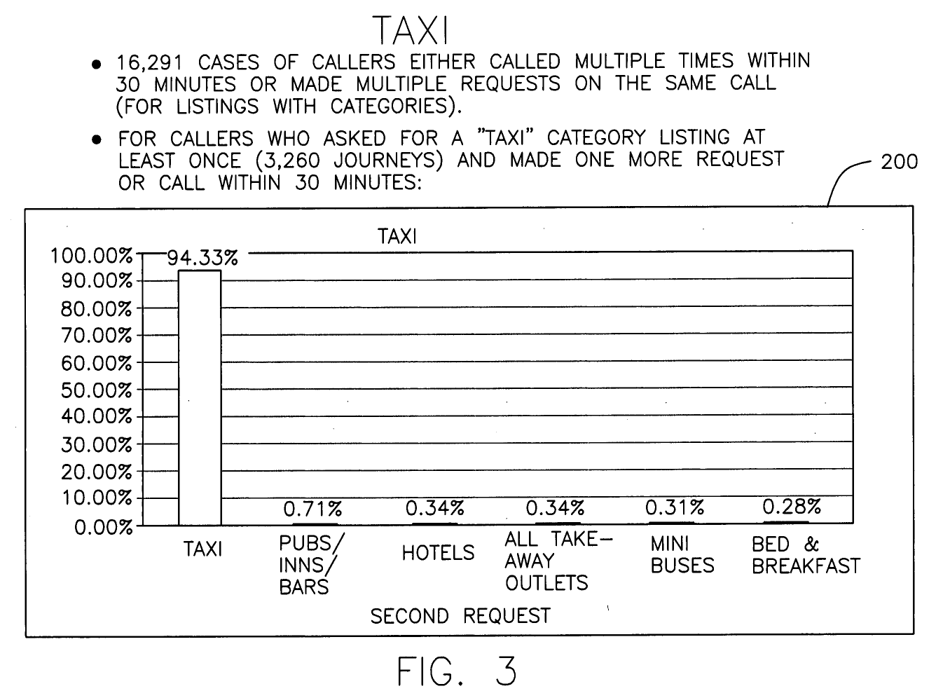

For example FIG. 3 illustrates trend result data for calls initially placed to DA platform 40 for a “taxi” category search (ie searches that, by their search terms used, resulted in a “taxi” SIC code listing being given in response as stored in results field 108). Here trend module 60 searched stored call records 100 for searches that resulted “taxi” listings as stored in field 108. Then, using the caller identifier field 102 and time and date field 104, this subset of listings was checked again for repeat callers where the same caller called again within a short time frame (such as less than 30 minutes, etc . . . ).

As seen in FIG. 3, the “taxi” results table 200 shows that when a caller to the directory assistance platform 40 first requests a contact information for a “taxi,” that same caller, shortly thereafter, made a second request for another taxi service. However, the other data in table 200 also shows that second requests by the same caller, after first requesting taxi information, were alternatively for any one of a pub, hotel, take out food, mini bus (limosine) service and bed and breakfast services. This suggests that typical “taxi” callers to DA platform 40, also may have interest in other commercial listings not directly related to taxis.

Thus, according to the present invention, trend module 60 of system 10, utilizing this data in table 200 is able to communicate with results generator 30 so that when a user 12 makes a search in search portal 20 for a “taxi”, the results provided may, in addition to taxi results, also include results for pubs, hotels, take out food locations, mini bus (limosine) services and bed and breakfast services, even though those terms were not included in the user's 12 search terms. Such an arrangement uses past data mined from telephonic directory assistance (DA platform 40 and call records 100) to enhance search portal 20 results by allowing system 10 to include not only results directed to the primary request but also to include results that may be directed to a next likely search.

It is note that in the above example trend module 60 utilizes data contained in results field 108 of call records 100 in order to develop trend data, it is also within the contemplation of the present invention, that trend module 60 may alternatively use data from request term field 106 of call records 100 to generate the desired trend data to use for request to portal 20 by users 12.

Call records 100, generated by past callers to DA platform 40 may include a first request term data in field 106 and second result data in field 108. However, these may not exactly correlate with one another. For example a caller may have requested “hotels” as a category but received a listing “XYZ house” which is listed as with both SIC codes for hotels and bead and breakfasts. Thus trend data analyzed by trend module 60 may exhibit different results depending on if the trend data is developed using request field 106 versus results field 108.

It is understood that trend module 60 of the present invention may use either request field 106, results field 108 or a combination of both fields when developing trend data for use in supplementing search results at portal 20 to users 12 as shown in the above example and following examples.

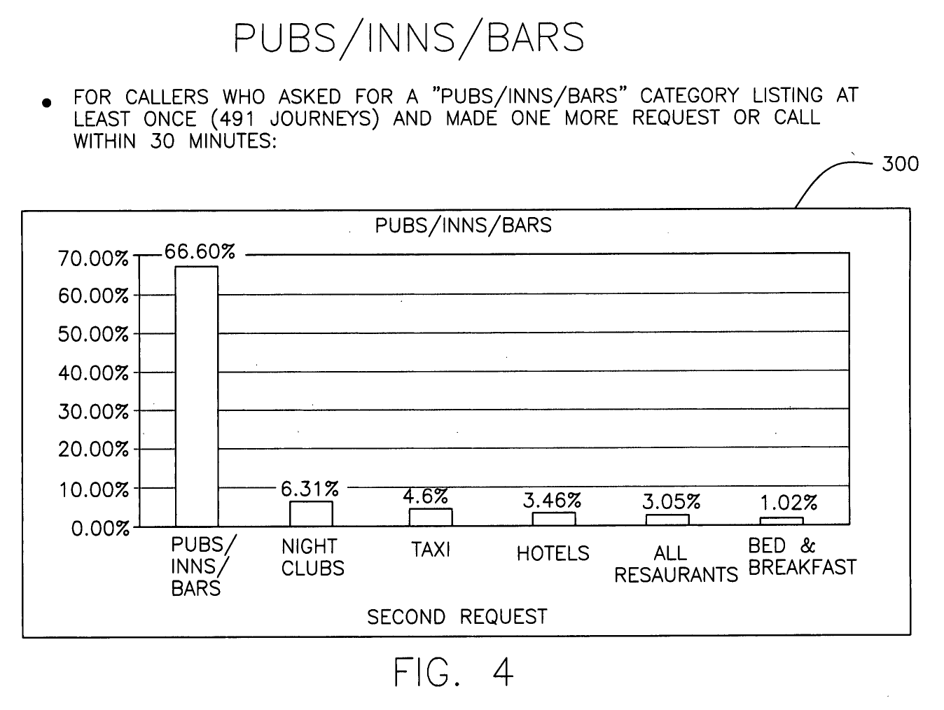

In another example of the present invention. FIG. 4 illustrates a similar chart 300 directed to initial telephonic searches for “pubs/inns/bars.” Thus, FIG. 4 shows that when callers to directory assistance platform 40 requested a listing from the category “pubs/inns/bars,” then within the next 30 minutes, if the same caller called back, their second request was for categories selected from the group of: pubs/inns/bars (a second time), night clubs, taxis, hotels, restaurants, bed and breakfasts. Thus, measuring this data at trend module 60, if a user 12 contacts portal 20 for a pub/inn/bar, then results generator 30 may produce a list that includes not only pubs/inns/bars, but also additional links/listings for night clubs, taxis, hotels, restaurants, and bed and breakfasts.

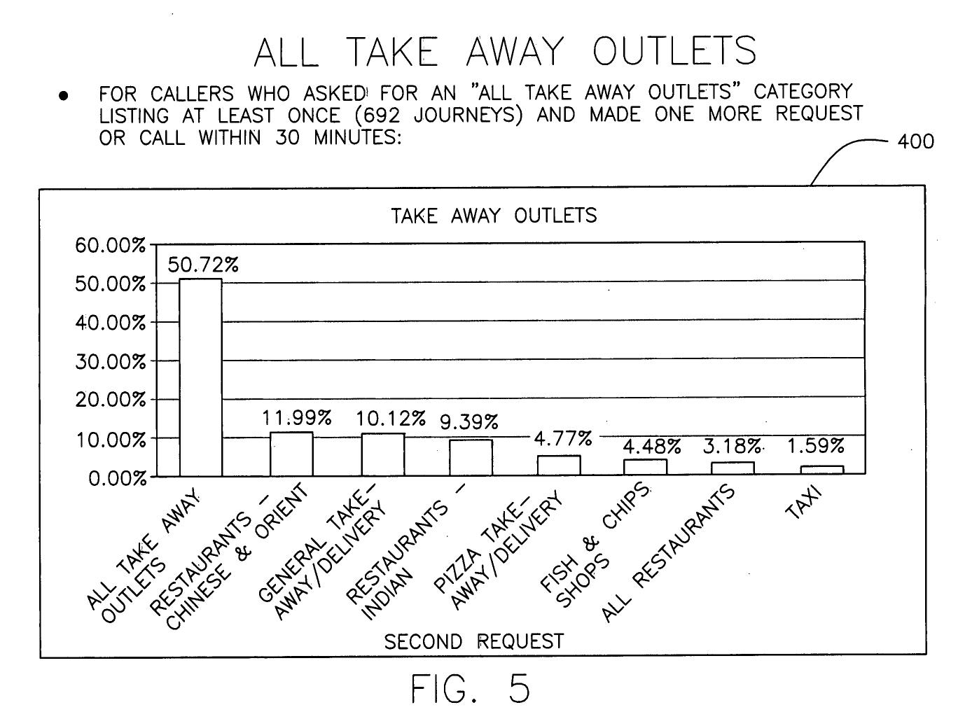

In another example, FIG. 5 illustrates a similar chart 400 directed to initial telephonic searches for “take away outlets.” Thus, FIG. 5 shows that when callers to directory assistance platform 40 requested a listing from the category “take away outlets,” then within the next 30 minutes if the same caller called back, their second request was typically was for a listing from the categories selected from the group of: take away outlets, Chinese restaurants, take away/delivery, Indian restaurants, pizza take away/delivery, fish and chips restaurants, all restaurants and taxis. Thus, using this data at trend module 60, if a user 12 contacts portal 20 for take away outlet, then results generator 30 may produce a list that not only includes take away outlets, but also includes listings/links for Chinese restaurants, take away/delivery, Indian restaurants, pizza take away/delivery, fish and chips restaurants, all restaurants and taxis.

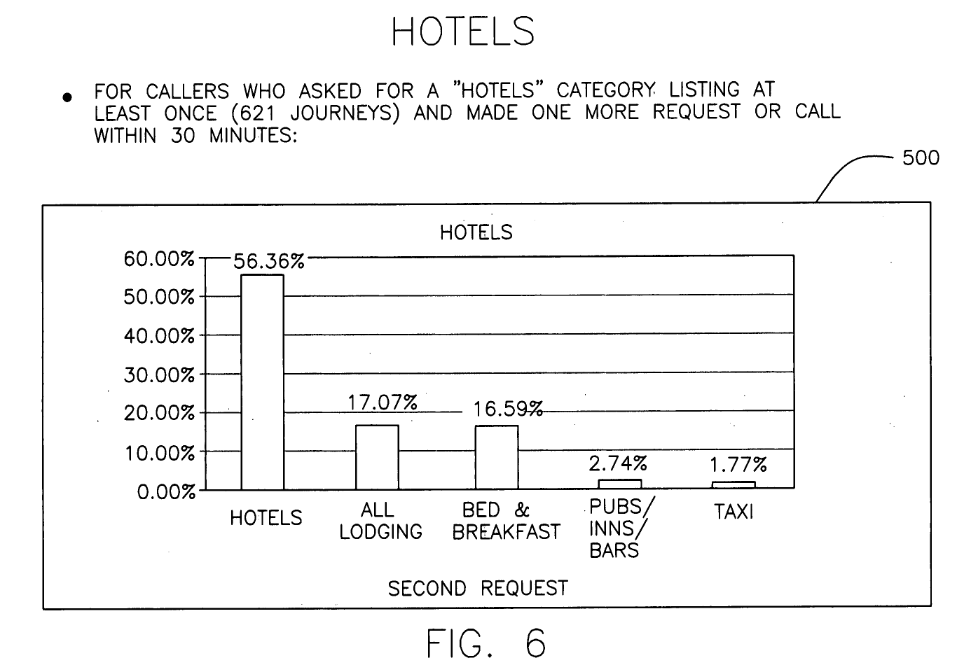

In another example, FIG. 6 shows a similar chart 500 directed to initial searches for “hotels.” Thus, FIG. 6 shows that when callers to directory assistance platform 40 requested a listing from the category “hotels,” then within the next 30 minutes if the same caller called back, their second request was for categories selected from the group of: hotels, all lodgings, bed and breakfasts, pubs/inns/bars and taxis. Thus, using this data at trend module 60, if a user 12 contacts portal 20 for hotels, then results generator 30 may produce a list that includes not only hotels, but also links/listings for all lodgings, bed and breakfasts, pubs/inns/bars and taxis.

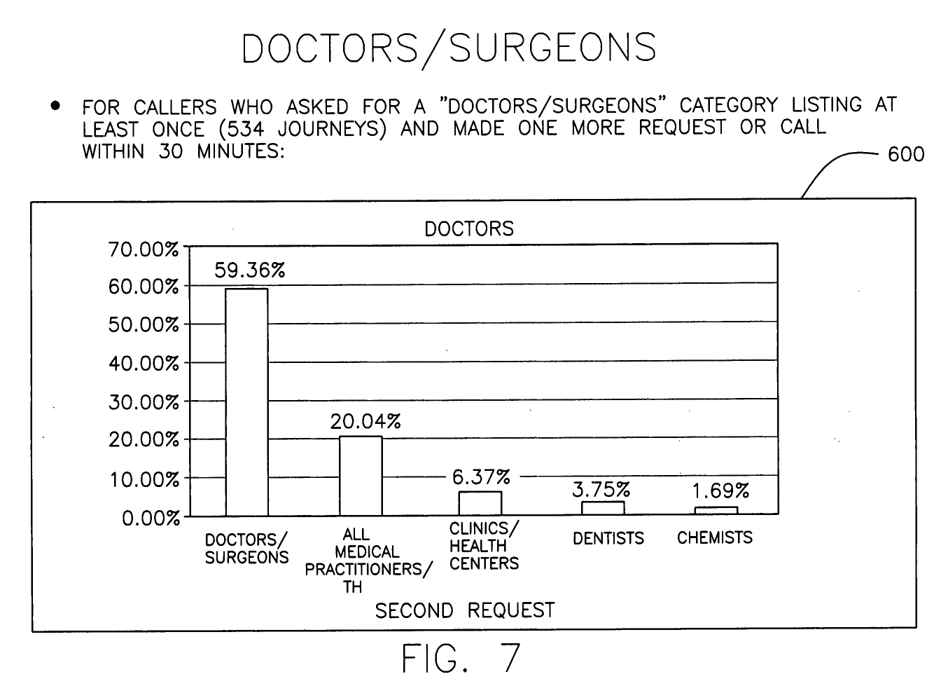

In another example, FIG. 7 shows a similar chart 600, directed to initial searches for “doctors/surgeons.” Thus, FIG. 7 shows that when callers to directory assistance platform 40 requested a listing from the category “doctors/surgeons,” then within the next 30 minutes if the same caller called back, their second request was for categories selected from the group of: doctors/surgeons, all healthy practitioners, clinics/health centers, dentists and chemists(pharmacists). Thus, using this data at trend module 60, if a user 12 contacts portal 20 for doctors/surgeons, then results generator 30 may produce a list that includes not only doctors/surgeons, but also all healthy practitioners, clinics/health centers, dentists and chemists(pharmacists).

Although the above discussed examples relate to trend data that is based on search request and results from certain “category” type stored DA requests it is also within the contemplation of the present invention to generate trend results based on stored call records 100 to DA platform 40 that were made for specific listings.

For example, trend module 60 may select a single listing result from field 108 (or request for listing from field 106) such as “XYZ theatre.” Thereafter trend module may review database 50 for stored listings 100 that are from the same caller making a second DA request within a predefined time frame. If the results showed that second calls showed a high propensity for restaurants in the area or even a certain specific nearby restaurant, then, when a user 12, making a similar request for “XYZ theatre” through search portal 20 receives their results, results generator 30 may supplement the results list with information on local nearby restaurants or even the specific restaurants as reflected in the trend data.

It is contemplated that the above examples of data generated by trend module 60 that is derived from stored call records 100 to tailor results in search portal 20 is for exemplary purposes only. Any similar trends that are derived and utilized similarly, are within the contemplation of the present invention as claimed.

In another embodiment of the present invention, trend module 60 may further employ time, date and location data from field 104 of stored data record 100 to generate more detailed trend data for use by search results generator 30. For example, as noted above stored call records 100 in database 50 for a first category request, if followed by a call from the same caller within a certain pre-defined time frame, typically result in the second category request following some trend. However, it is noted that such trends may be affected by the geographic location of the callers making the directory assistance calls.

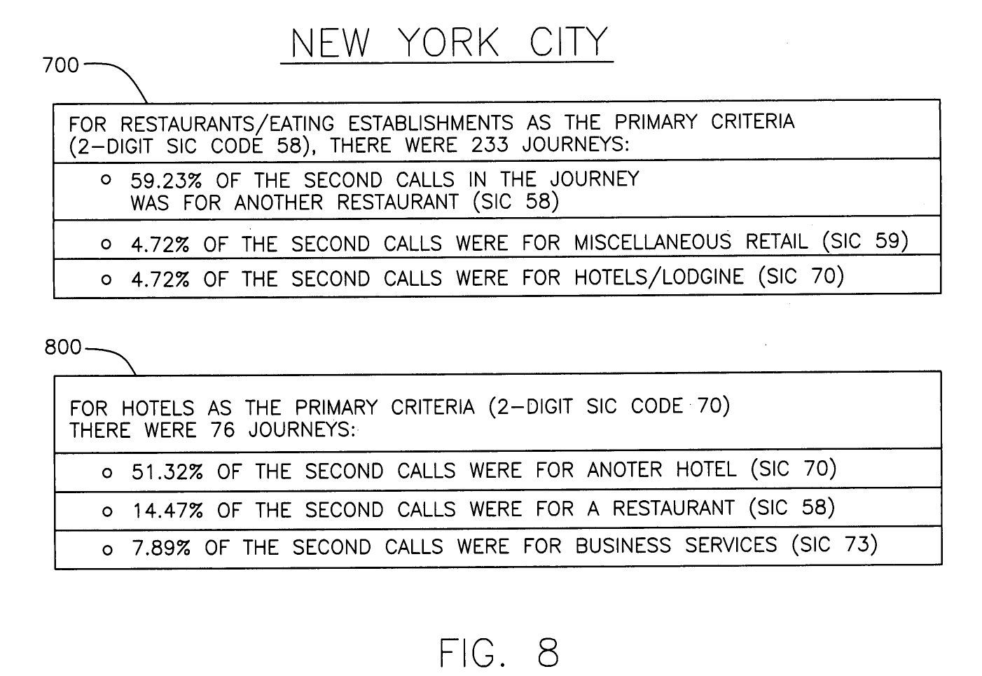

For example, FIG. 8 shows table 700 for first requests for eating establishments in New York City. Table 700 shows that second requests from these callers within 30 minutes by the same caller were for: another restaurant, miscellaneous retail; and hotels. Thus, when user 12 makes a request for restaurants to search portal 20 and the request originates from New York City, trend module 60 may assist results generator 30 to set the results accordingly, as discussed above with FIG. 3-7. It is noted, that the location of user 12 making a web search to portal 20 is knowable using known location determinations methods for both land line and wireless web access connections. It is contemplated that system 10 and portal 20 have access to location data in an automated manner or are otherwise directly informed of the location by user 12.

FIG. 8 also shows a second table 800 for first requests for “hotels” in New York City followed by second requests from these callers within 30 minutes. The subsequent requests by these callers were for: another hotel, restaurants; and business services.

However, as can be seen from this data, one subset of secondary request after restaurants was for hotel information. However, such second request trends are likely influenced by the location of user 12 making such requests being New York City because it is a tourist location. It is contemplated that trend module 60, while reviewing stored records 100 (including time, date and location field 104) generates different trend data for different locations.

For example, it is likely that trend data from records 100 will not show secondary calls (after first calls for restaurants—table 700) for hotels when the results are limited to non-tourist destinations, such as rural areas. Rather, it is possible that secondary calls stored in records 100 for such non-tourist destinations may show second request trends for weather or directions (more typical for non-tourist users of system 10). Thus, it is contemplated that the present invention generates more detailed trend data by incorporating the location of previous callers to DA platform 40 for use in supplementing search results to users 12 using portal 20 that are contact system 10 from the same or nearly the same geographic location.

Likewise, it is within the contemplation of the present invention to supplement trend information using time data, when trend module 60 reviews past call records 100. For example, it is contemplated that data will likely show that callers for a first category request to DA platform 40, followed by a second call within a predefined time frame by the same caller to platform 40, will exhibit one set of trend data for one time of day, and another trend at a different time of day. This may be true even for the same category initial request and from the same geographic location.

For example, trend module 60, when reviewing call records for initial requests for “bar/pub/inn” in New York City at 12:00 noon may find that secondary requests by the same caller within 30 minutes likely were requesting taxi information. But using the same initial category and geographic location (“bar/pub/inn” in New York City) but reviewing records from 9:00 pm are likely to show secondary requests by the same caller within 30 for hotel information. Thus when new users 12 are making searches for “bar/pub/inn” in New York City, the supplemental results offered to user 12 in response to the query for “bar/pub/inn” will be supplemented with taxi information in the mornings but, hotel information when the requests are being made at night.

Thus, it is contemplated that the present invention generates trend data based on the time of previous callers to DA platform 40 for use in supplementing search results to users 12 using portal 20 that are calling during the same corresponding time.

It is noted that trend module 60, in addition to taking time (as recorded in field 104 of records 100) into account it may further evaluate such trends over various time frames, with varying rates of updating. For example, trend module 60 may advantageously use call records 100, dated in field 104, from periods as short as several minutes up to several years to take into account different types of trends, with updates to the trend analysis occurring at correspondingly frequent updates.

It is understood that trend module 60 of the present invention may further take into account sub-combinations of trend data using both time and geographic locations together. Thus, it is contemplated that the present invention generates trend data based on the time and geographic location of previous callers to DA platform 40 for use in supplementing search results to users 12 using portal 20 that are calling during the same corresponding time for the same corresponding geographic location.

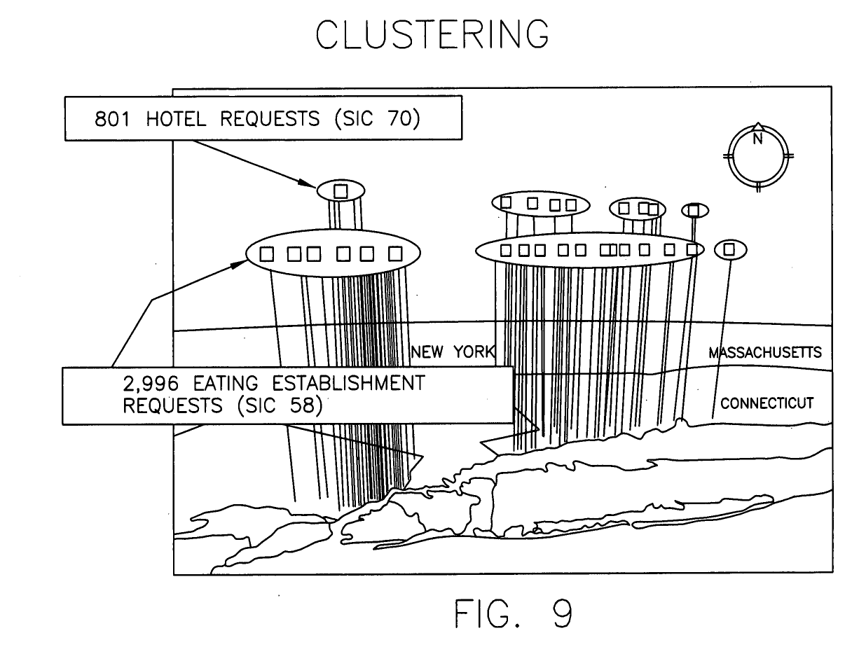

In another embodiment of the present invention, FIG. 9 shows a geographic distribution of calls for particular categories. For example, “hotel” requests to directory assistance platform 40 as stored in records 100 may exhibit a trend for a particular geographic location such as the geographic distance a caller is willing to accept for a listing. The same request in a different geographic location such as Connecticut may exhibit a broader distance range, as the more mobile Connecticut customer may be willing to travel further. Similar results are show in FIG. 9 for restaurant requests.

In one embodiment, trend module 60 may utilize this geographic location constraint trend data from prior DA platform 40 search records 100 and modify results lists for requests for the same category to search portal 20 of system 10 when the location of user 12 making the request is known.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A system for providing search results, said system comprising:
a portal for receiving search requests;
a means for obtaining prior search results from telephonic directory assistance requests; and
a trend module for analyzing said obtained prior search results from telephonic directory assistance requests; wherein results provided to a user in response to said search request received at said portal are affected by said prior search results from telephonic directory assistance requests.

2. The system as claimed in claim 1, wherein said portal for receiving search requests is a web portal fro receiving internet search requests.

3. The system as claimed in claim 1, wherein said requests received at said portal are business listing requests for business contact information.

4. The system as claimed in claim 1, further comprising a directory assistance system for providing search results for telephonic directory assistance requests.

5. The system as claimed in claim 1, wherein said results provided to a user in response to said search request received at said portal are supplemented with additional contact information that is obtained from said trend module.

6. The system as claimed in claim 1, wherein said prior search results from telephonic directory assistance requests are stored in call records.

7. The system as claimed in claim 6, wherein each of said call record include a caller identifier field, time date and location field, request field and results field.

8. The system as claimed in claim 7, wherein review by said trend module of said prior search results includes a review of said results field to determine a category of a result provided to a caller in response to a telephonic directory assistance requests.

9. The system as claimed in claim 7, wherein review by said trend module of said prior search results includes a review of said request field to determine a category of a result requested by a caller during telephonic directory assistance requests.

10. The system as claimed in claim 7, wherein said review by said trend module of said prior search results includes a review of said time, date and location field to determine a category of a result provided to a caller of a in response to a telephonic directory assistance requests.

11. The system as claimed in claim 7, wherein said review by said trend module of said prior search results includes a review of said time, date and location field, said request field and said results field to analyze said obtained prior search results from telephonic directory assistance requests.

12. The system as claimed in claim 7, wherein said review by said trend module of said prior search results includes a review of said caller identifier field to determine when a caller, who had previous made a directory assistance requests, makes a second telephonic directory assistance request within a predefined time.

13. The system as claimed in claim 12, wherein said predefined time is a second telephonic directory assistance request within 30 minutes.

14. A method for providing search results, said method comprising the steps of:
receiving search requests at a portal;
obtaining prior search results from telephonic directory assistance requests; and
analyzing said obtained prior search results from telephonic directory assistance requests at a trend module; wherein results provided to a user in response to said search request received at said portal are affected by said prior search results from telephonic directory assistance requests.

15. The method as claimed in claim 14, wherein said obtained prior search results from telephonic directory assistance requests are stored in call records.

16. The method as claimed in claim 15, wherein each of said call record include a caller identifier field, time date and location field, request field and results field.

17. The method as claimed in claim 16, wherein review by said trend module of said prior search results further includes the step of reviewing said results field to determine a category of a result provided to a caller in response to a telephonic directory assistance requests.

18. The method as claimed in claim 16, wherein review by said trend module of said prior search results further includes the step of reviewing of said request field to determine a category of a result requested by a caller during telephonic directory assistance requests.

19. The method as claimed in claim 16, wherein said review by said trend module of said prior search results further comprises the step of reviewing of said time, date and location field to determine a category of a result provided to a caller of a in response to a telephonic directory assistance requests.

20. The method as claimed in claim 16, wherein said review by said trend module of said prior search results further comprises the step of reviewing of said time, date and location field, said request field and said results field to analyze said obtained prior search results from telephonic directory assistance requests.

21. The method as claimed in claim 16, wherein said review by said trend module of said prior search results further comprises the step of reviewing of said caller identifier field to determine when a caller, who had previous made a directory assistance requests, makes a second telephonic directory assistance request within a predefined time.

22. The method as claimed in claim 21, wherein said predefined time is a second telephonic directory assistance request within 30 minutes.
